(19) United States
(12) Patent Application Publication
(10) Pub. No.: US 2017/0179668 A1
(43) Pub. Date: Jun. 22, 2017

(54) Gas Flow Laser

(71) Applicant: Alexander V. KRASNOV, Holden, MA (US)

(72) Inventor: Alexander V. KRASNOV, Holden, MA (US)

(21) Appl. No.: 15/128,715

(22) PCT Filed: Mar. 30, 2015
(86) PCT No.: PCT/US2015/023397

§ 371 Date: Sep. 23, 2016

Related U.S. Application Data
(60) Provisional application No. 61/971,809, filed on Mar. 28, 2014.

(51) Int. Cl. H01S 3/03; H01S 3/036; H01S 3/223; H01S 3/041; H01S 3/0979; H01S 3/038; H01S 3/04

(52) U.S. Cl. CPC H01S 3/03; H01S 3/038; H01S 3/036; H01S 3/0405; H01S 3/041; H01S 3/0979; H01S 3/2232

(57) ABSTRACT

Apparatus and methods relating to a gas flow laser are disclosed herein. The gas flow laser includes an eccentrically aligned inner casing within a cylindrical or oval outer shell thereby creating a narrow gas flow path in which the speed of the gas flow may approach sonic or supersonic speeds. An optical resonator is within the narrow gas flow path, and one or more diffusers are located downstream of the optical resonator to improve operating efficiency of the gas flow laser.

### TECHNICAL FIELD

Generally, a gas flow laser is taught. More particularly, a gas flow laser having one or more diffusers that may, for example, increase efficiency of filtering, catalytic processes, heat exchange, and/or the overall laser operation.

### BACKGROUND

Powerful lasers can be created by optically resonating one or more laser beams through plasmatic media. Plasmatic media may be formed by exciting a gas flow using, for example, a high frequency discharge (HFD) electrode and/or radio frequency (RF) excitation, which may be powered by an HFD and/or RF power supply, respectively. Many gas lasers utilize a gas flow having an increased flow rate created by an external blower that blows the gas medium through the laser. The gas flow may subsequently exit the laser and enter the atmosphere. However, designs that discharge the gas medium into the atmosphere are often inefficient and subject to environmental scrutiny.

To address these issues, closed loop gas flow laser designs have been implemented. An example of such a design might use a blower that increases the flow rate of a gas medium, which flows through the laser and back into the blower via a closed network or circuit of pipes and/or ducts. However, even such closed loop designs are often inefficient.

Chemical catalysts and/or filters have been introduced into some laser designs, generally located downstream of the lasers' plasma cavity and/or optical resonator cavity, and in some cases have increased laser operating efficiency. In a closed loop system, cooled, filtered, and/or catalyzed gas medium re-entering the blower can increase the operating efficiency. However, even in closed loop gas flow designs utilizing catalytic, filtering, and heat exchange processes, efficiency is often relatively low.

Thus, there is a need to overcome the issues of existing systems.

### SUMMARY

The present disclosure is directed to methods and apparatus for a closed loop forced gas flow subsonic or supersonic transfer gas flow laser having radio frequency (RF) excitation, the plasma excitation occurring within a plasma cavity, and an optical resonator cavity upstream of one or more diffusers. A blower forces a gas medium through a laser body or housing, which has an eccentrically positioned inner casing within a cylindrical outer shell to create a narrowed area for increasing a gas flow speed, which may be subsonic, sonic, supersonic, or any combination thereof. The diffuser decelerates the gas flow and/or makes the flow non-laminar so that, for example, subsequent filtering, catalytic processes, and/or heat exchange processes may be more efficient.

Generally, in one aspect, a closed loop gas flow laser is provided. The closed loop gas flow laser has an outer shell and an inner casing that is eccentrically aligned within the outer shell, which forms a narrowed area opposite a widened area, and a gas may flow through either or both. The outer shell is electrically grounded and the inner casing includes a dielectric material. The inner casing has an inner surface on which a radio frequency (RF) electrode is positioned. The RF electrode is powered by a RF power supply, and the RF electrode may be used to cause excitation of the gas medium used in the laser. The laser includes a gas flow path substantially formed between the outer shell and the inner casing. A plasma cavity and an optical resonator are in the gas flow path, and each is formed between the outer shell and the inner casing. The outer shell has an inner surface on which a dielectric insulating layer is positioned, and the dielectric insulating layer is positioned adjacent the plasma cavity, the optical resonator, or both. A diffuser is located in the gas flow path downstream of the optical resonator cavity. The diffuser has a first edge that is proximate the optical resonator and a second edge that is opposite the diffuser's first edge. The diffuser widens from the first edge to a widest point, and tapers from the widest point to the second edge. An external blower is provided and is in fluid communication with the gas flow path, and may be used to force and/or accelerate the gas medium through the gas flow path.

Optionally, an additional or second diffuser may be located in the gas flow path, wherein one diffuser is a supersonic diffuser and the other is a subsonic diffuser. The outer shell may have a circular cross section or it may have an elliptical cross section. A plurality of laser modules may be provided and may be optically combined, sharing a common optical resonator. An output laser may emit from the optical resonator and may be in optical communication with an optical fiber, which in turn may be in optical communication with an optical collimator, with the optical fiber interposed between the output laser and the optical collimator. An optical resonator frame may be provided and may be in sealed combination with the outer shell. One or more optical resonator tubes may be attached to a laser module, with the laser module in sealed combination with the outer shell. A heat exchanger may be downstream of the optical resonator cavity. The optical resonator may be positioned within the plasma cavity and/or at least partially downstream of the plasma cavity. The outer shell and the inner casing may be hermetically sealed with at least one side flange. The widest point of the diffuser may be within the first half of the diffuser, with the first half measured from the first edge, and/or the widest point may be within the first quarter of the diffuser, also measured from the first edge.

Generally, in another aspect, a gas flow laser is provided having an outer shell and an inner casing. The inner casing is eccentrically aligned with the outer shell thereby creating a gas flow path having a narrowed gas flow area. The inner casing has a RF electrode on an interior surface that is adjacent the narrowed gas flow area. The RF electrode is in electrical communication with a RF power supply. A dielectric insulating layer is on an interior surface of the outer shell and is positioned opposite the narrowed gas flow area from the RF electrode. A plasma cavity is formed in the narrowed gas flow area and is interposed between the RF electrode and the interior surface of the outer shell. An optical resonator is also in the narrowed gas flow area and is within the plasma cavity and/or downstream of the plasma cavity. The optical resonator is at least partially defined by an optical source an output coupler. At least one diffuser is located downstream of the optical resonator. The diffuser has a first edge that is proximate the optical resonator, a second edge that is opposite the first edge, and a widest point between the first and second edges.

Optionally, the gas flow laser may also include a high speed gas blower that provided an inlet gas flow to the gas flow path. The gas flow path may include a flow deflector within the gas flow path. The laser may include a filter, a catalyst, and/or a heat exchanger, which if included, may be positioned downstream of the optical resonator. At least one additional filter, catalyst, and/or heat exchanger may be included and, if included, may also be positioned downstream of the optical resonator. The optical resonator may include one or more resonator mirrors in optical communication with the optical source and the output coupler.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the embodiments.

FIG. 1 illustrates an embodiment of a radio frequency (RF) excitation laser having an optical fiber and an optical collimator attached thereto;

FIG. 2 illustrates a top plan view of one embodiment of the laser cavity for use in the laser of FIG. 1;

FIG. 3 illustrates two laser module embodiments combined and sharing a common optical resonator;

FIG. 4 illustrates three of the laser modules of FIG. 3 combined and sharing a common optical resonator;

FIG. 5 illustrates a side sectional view of an embodiment of a RF excitation laser;

FIG. 6A illustrates a side elevation view of an embodiment of a resonator frame;

FIG. 6B illustrates a front elevation view of the resonator frame of FIG. 6A;

FIG. 7A illustrates a side elevation view of an alternative embodiment of a resonator frame;

FIG. 7B illustrates a front elevation view of the resonator frame of FIG. 7A;

FIG. 8 illustrates a partial perspective sectional view of an embodiment of a RF excitation laser;

FIGS. 9A and 9B illustrate a combined side and top sectional view of the laser of FIG. 8 and embodiments thereof; and

FIG. 10 illustrates a combined side and top sectional view of the embodiment of a RF excitation laser having a generally elliptical shape.

### DETAILED DESCRIPTION

It is to be understood that the embodiments are not limited in their application to the details of construction and the arrangement of components set forth in the following description or illustrated in the drawings. Other embodiments are possible and may be practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected” and “coupled” and variations thereof herein are used broadly and encompass direct and indirect connections and couplings. In addition, the terms “connected” and “coupled” and variations thereof are not restricted to physical or mechanical connections or couplings.

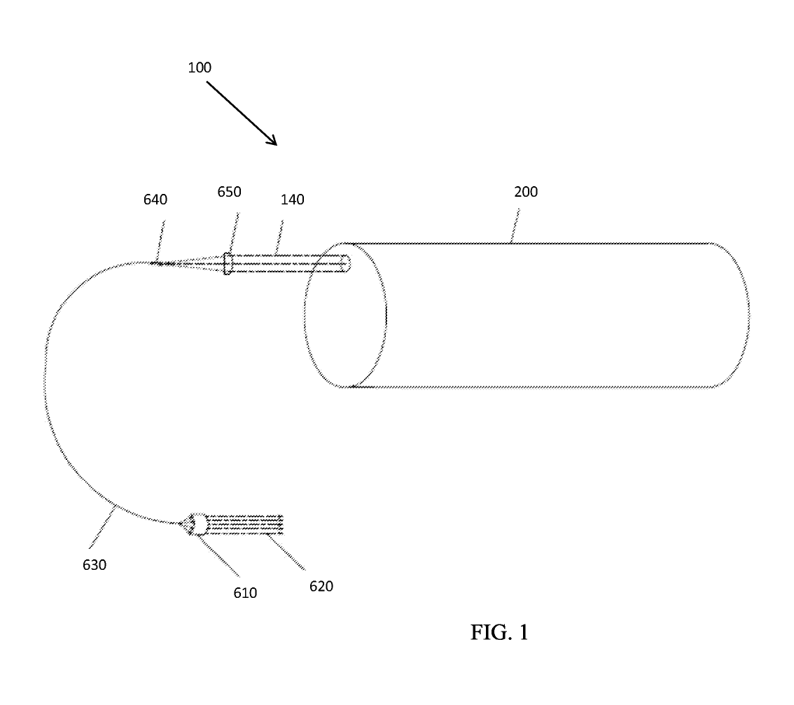

Referring initially to FIG. 1, a gas flow laser may include or be in optical communication with an optical fiber 630, which may be used to direct output laser 140 as desired. This may be helpful in some applications, such as, for example, material processing applications. In some embodiments, output laser 140 may be focused through focusing lens 650, which may be optically and/or operatively connected to optical fiber 630 by optical coupler 640. Optical fiber 630 may direct the output to optical collimator 610 which may focus and/or direct the output into one or more parallel output beams 620. In some embodiments, output laser 140 may have wave lengths of about 5 microns or less.

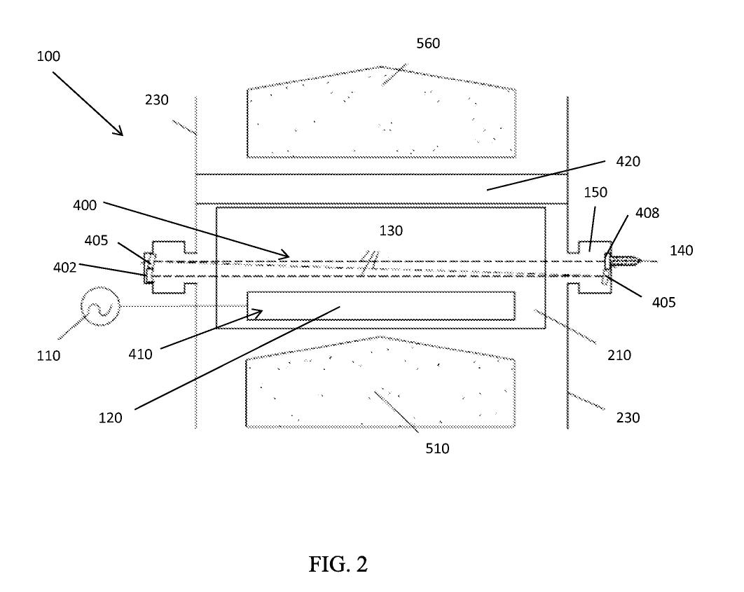

Referring now to FIG. 2, a section of gas flow laser 100 including plasma cavity 410 and optical resonator cavity 400 is depicted. Excitation of a gas medium, such as may be present in an inlet gas flow 510, may occur in plasma cavity 410 by subjecting inlet gas flow 510 to energy. For example, radio frequency (RF) excitation may be introduced to gas flow 510 by a RF electrode 120. Plasma cavity 410 may be located between outer shell 200 and inner casing 300. RF electrode 120, which may be in electrical communication with a RF power supply 110, may be placed on an internal surface of inner casing 300 adjacent plasma cavity 410. In this way, RF electrode 120 may be add energy to inlet gas flow 510 without interrupting the laminar flow characteristics of gas flow 510, which may be desirable for efficient operation of gas flow laser 100. A dielectric insulating layer 210 may be included to, for example, provide insulation between the medium used in gas flow laser 100 and outer shell 200. If included, dielectric layer 210 may be located substantially opposite plasma cavity 410 from RF electrode 120.

An optical resonator cavity 400 may be located downstream of, partially downstream of, or positioned substantially within, plasma cavity 410. The plasmatic gas flow generated in plasma cavity 410 may be used to amplify optical beam 130 passing through optical resonator cavity 400. For example, optical beam 130 may be introduced to optical resonator cavity 400 via optical source 402, may pass through the plasmatic gas flow thereby being further excited, and may exit gas flow laser 100 via an output coupler 408 as an output laser 140. To generate further excitation of output laser 140, optical beam 130 may be caused to make multiple passes through optical resonator cavity 400 by, for example, reflecting optical beam 130 from one or more resonator mirrors 405. As shown in FIG. 2, any or all of optical source 402, resonator mirrors 405, and output coupler 408 may be placed outside of gas flow (e.g. 510, 560) so as to limit or prevent interference with the laminar flow characteristics. A structure such as a laser module 150 may be used to achieve this purpose, or for any other reason, by, for example, housing and/or supporting optical source 402, resonator mirrors 405, and/or output coupler 408. As discussed above, laminar gas flow characteristics in optical resonator cavity 400 and/or plasma cavity 410 may facilitate and/or improve efficient operation of gas flow laser 100.

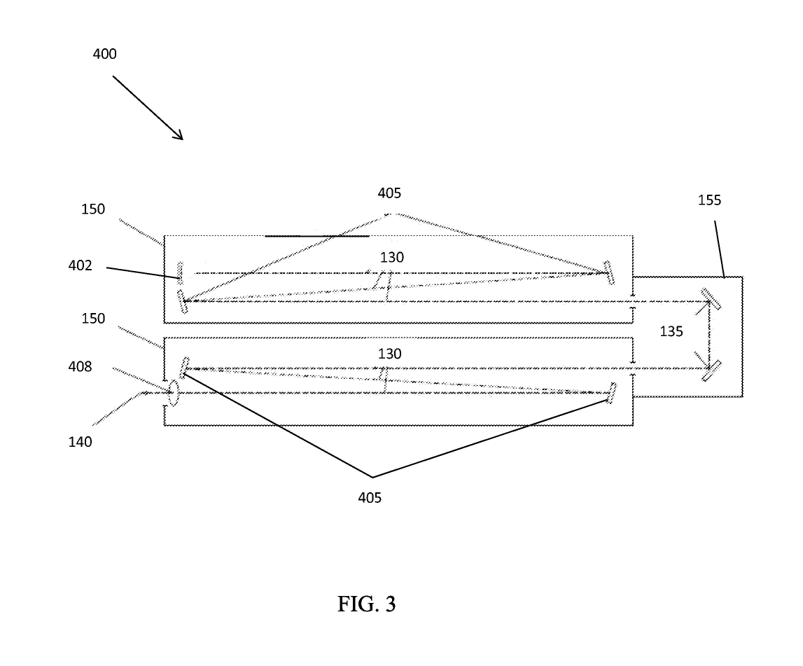

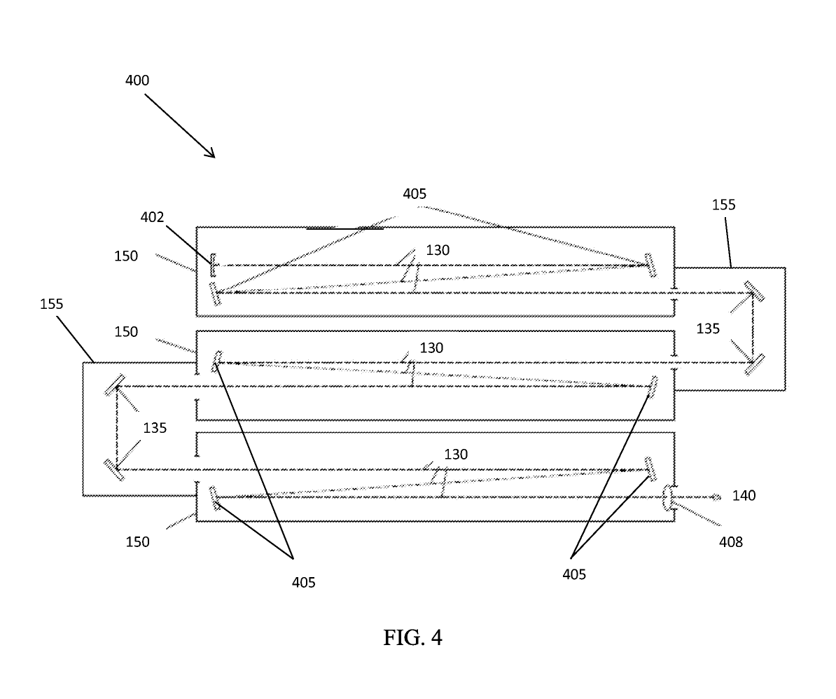

As shown in FIGS. 3 and 4, a plurality of laser modules 150 may be used in combination within optical resonator cavity 400 to, for example, amplify the power of output laser 140. For example, two laser modules 150 in combination (as shown in FIG. 3) may increase the output laser 140 power by 2× that of the embodiment depicted in FIG. 2, whereas three laser modules 150 in combination (as shown in FIG. 4) may increase the output laser 140 power by 3× that of the embodiment depicted in FIG. 2. Turning mirrors 135 may be included to, for example, direct optical beam 130 from one laser module 150 to the next laser module 150. Module connectors 155 may be included to house and/or support turning mirrors 135. More laser modules 150 may be combined to further increase the output laser 140 power and/or amplification. Laser modules 150 may be attached or connected mechanically or otherwise, and it is understood that turning mirrors 135 and module connectors 155 are merely one exemplary embodiment. It is further understood that any or all of optical resonator cavity 400, laser modules 150, and/or module connectors 155 may be partially or completely within plasma cavity 410, although plasma cavity 410 is not illustrated in FIGS. 3 and 4.

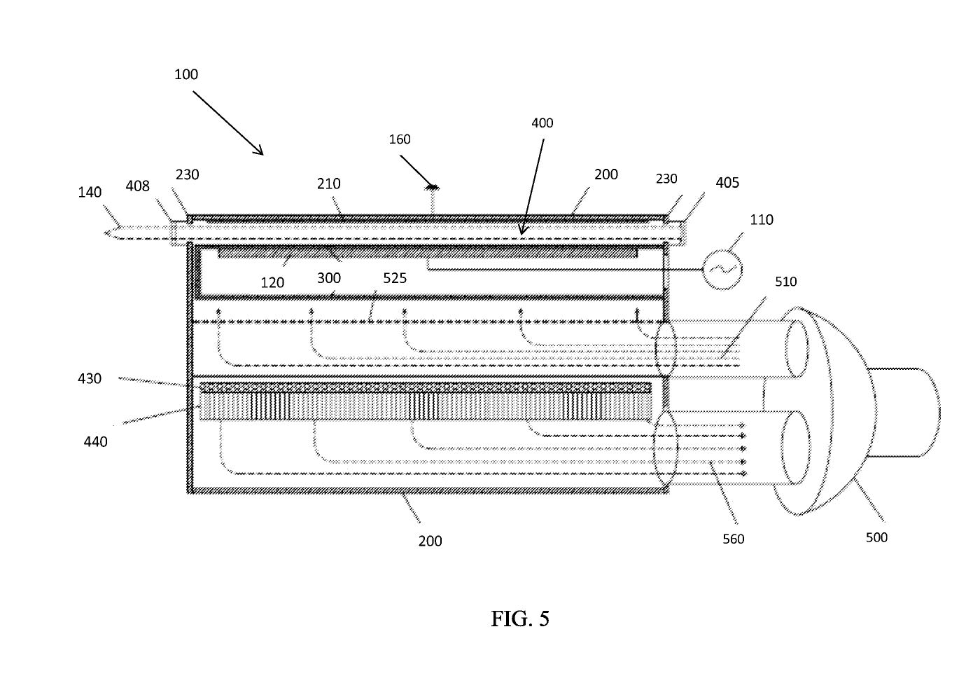

Referring now to FIG. 5, a gas flow laser 100 is shown wherein an inlet laser gas flow 510 is provided by blower 500 to enter outer shell 200 through gas distributor 520. Gas flow 510 enters outer shell 200 and passes through a uniform metal mesh screen 525 in order to form a uniform and laminar inlet gas flow 510 within the outer shell 200. Gas flow 510 then passes through plasma cavity 410 which, as discussed above, may be formed between dielectric insulating layer 210 and inner casing 300. The RF power supply 110 is in electrical communication with electrical ground 160 and/or RF electrode 120, which is located on the internal surface of the inner casing 300 within the plasma cavity 410. The output laser 140, before leaving the optical resonator cavity 400 via output coupler 408, exhibits amplification between the resonator mirrors 405 located within and/or at least partially defining the optical resonator cavity 400. One or more side flanges 230, if included, may form ends of, and/or hermetically seal, optical resonator cavity 400, outer shell 200, and/or the inner casing 300 from, for example, the outside environment. Inlet gas flow 510 may pass through plasma cavity 410, optical resonator cavity 400, a catalyst or filter 430, and/or a heat exchanger 440, before returning to blower 500 as outlet gas flow 560 to continue the closed loop cycle. Catalyst or filter 430, which may include both a catalyst and a filter, may be used to, for example, chemically catalyze and/or filter the gas medium to create a more efficient inlet gas flow 510 upon reentry into outer shell 200. Heat exchanger 440 may be provided to, for example, cool the gas medium so that inlet gas flow 510 is cooler upon reentry into outer shell 200, which may result in more efficient operation of gas flow laser 100.

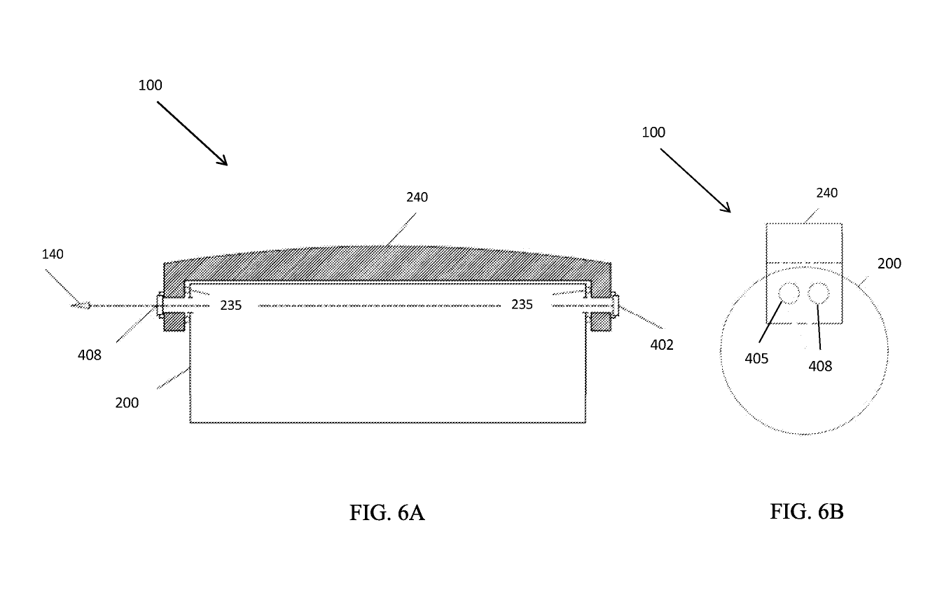

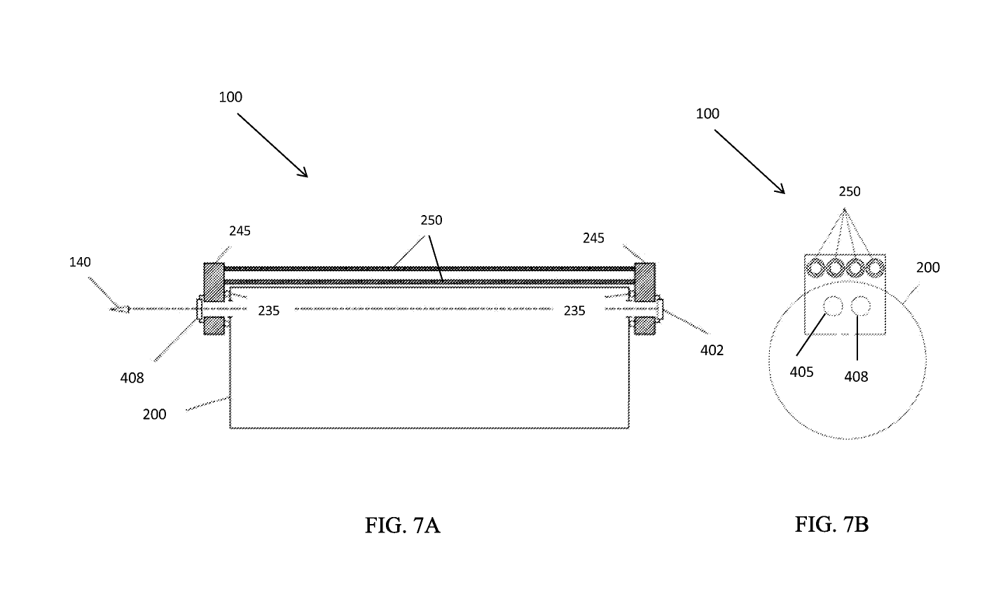

Referring now to FIGS. 6A-7B, embodiments of a resonator frame 240 and resonator rods 250 are illustrated, respectively. FIGS. 6A and 6B show various views of a first embodiment including resonator frame 240 and FIGS. 7A and 7B show various views of another embodiment using resonator rods 250 and end caps 245. In some embodiments, resonator frame 240, resonator rods 250, and/or end caps 245 may be substantially mechanically independent from outer shell 200. Resonator frame 240 and/or resonator rods 250 may be attached or connected to outer shell 200. One or more seals 235 may be interposed between outer shell 200 and resonator frame 240, end cap 245, and/or resonator rod 250 as appropriate. If included seals 235 may be, for example, soft O-ring type gaskets or seals. Thus, for example, a seal or vacuum seal may be formed on either or both ends of outer shell 200 at or near resonator frame 240, resonator rod 250, and/or end cap 245.

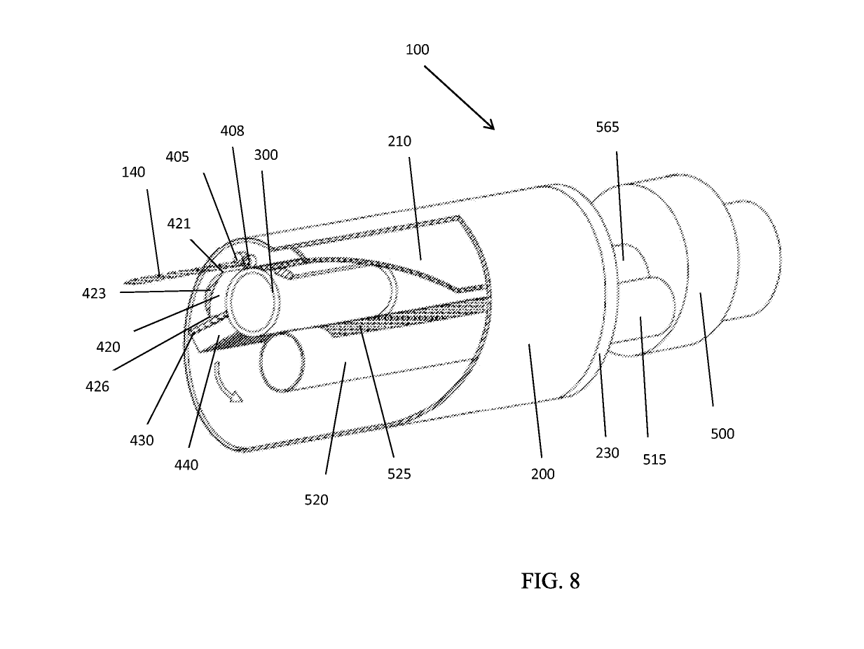

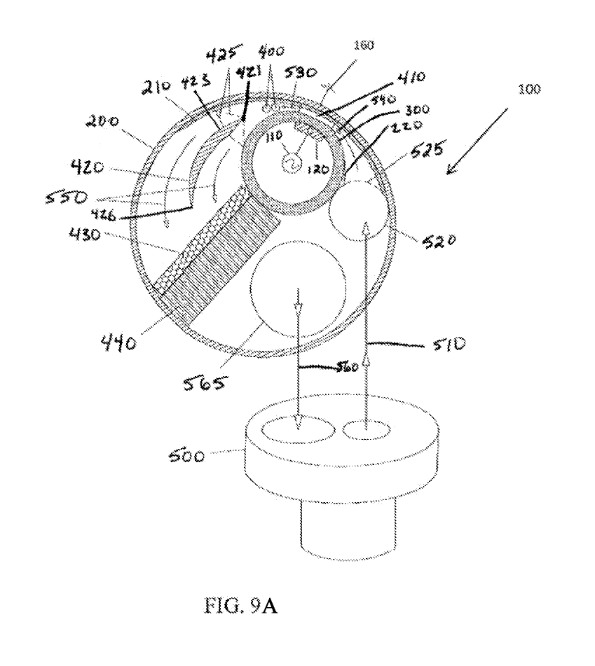

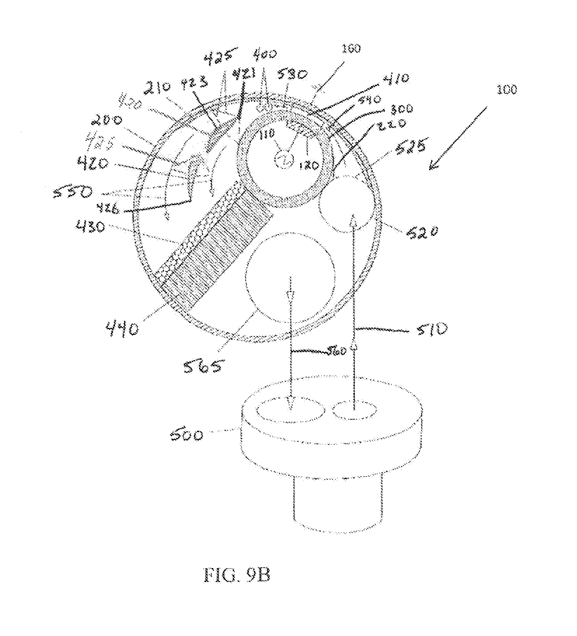

Referring now to FIGS. 8 and 9, an embodiment of a gas flow laser 100 is depicted having outer shell 200 and inner casing 300. Inner casing 300 may be eccentrically and/or non-centrically positioned within outer shell 200 to form a narrowed gas flow path or area through either or both of a subsonic gas flow area (or subsonic flow) 540 and a supersonic gas flow area (or supersonic flow) 530 so that, in some embodiments, inlet gas flow 510 can be accelerated to a supersonic gas flow. Inlet gas flow 510 may be caused to enter outer shell 200 by, for example, blower 500, which may be external and/or turbo, and/or inlet gas flow 510 may enter outer shell 200 through mesh 525 of gas distributor 520 before being accelerated to a faster subsonic flow in subsonic gas flow area 540 and/or to a supersonic gas flow in supersonic gas flow area 530. It is understood that the gas flow may reach sonic or supersonic speeds, but in some embodiments the gas flow may never reach sonic or supersonic speeds. It is further understood that blower 500 may provide the pressure ratio for inlet gas flow 510 for sonic or supersonic speeds, so that any acceleration that occurs may be from other than subsonic gas flows.

Plasma cavity 410 and/or optical resonator cavity 400 may be located partially or substantially completely within either or both of subsonic gas flow area 540 and/or supersonic gas flow area 530. The gas is excited by RF electrode 120 in plasma cavity 410 where it may achieve a plasma or plasma like state. Optical beam 130 may be amplified in optical resonator cavity 400 by passing through the plasmatic gas medium and between optical resonator mirrors 405 to form output laser 140. In some embodiments, a laser may traverse the plasma medium several times between a plurality of optical resonator mirrors 405 before exiting as output laser 140.

Downstream of plasma cavity 410 and/or optical resonator cavity 400, if either or both are included, there may be shocks 425 and/or one or more baffles or diffusers 420. Diffuser 420 may decelerate, slow, and/or disrupt the laminar gas flow so that catalyst or filter 430 and/or heat exchanger 440 may operate more effectively and/or efficiently, and/or to optimize the gas flow characteristics of outlet gas flow 560. In some embodiments, having accelerated and/or laminar gas flow 510 upstream of and/or within plasma cavity 410 and/or optical resonator cavity 400 may result in improved efficiency of gas flow laser 100, while a non-laminar or decelerated gas flow 550 at catalyst or filter 430 (or both) and/or at heat exchanger 440 may further improve the efficiency of gas flow laser 100. Thus, diffuser 420 and/or shocks 425 may be positioned downstream of optical resonator cavity 400 and/or plasma cavity 410 to not decelerate or disrupt the laminar flow characteristics of inlet gas flow 510, while also being positioned upstream of catalyst or filter 430 and heat exchanger 440 to cause deceleration and disruption of the laminar gas flow characteristics to result in decelerated gas flow 550. In this way, for example, efficiency of gas flow laser 100 may be optimized.

It is understood that one or more diffusers 420 and/or one or more shocks 425 (as depicted in FIGS. 9A and 9B) may decelerate and/or slow either or both of supersonic flow 530 and subsonic flow 540. For example, one or more shocks 425 and/or a leading or first edge(s) 421 of diffuser(s) 420 may meet supersonic flow 530 (and/or subsonic flow 540); may decelerate, slow, and/or change supersonic flow to a subsonic or decelerated gas flow 550; and/or may further decelerate, slow, and/or change a flow to decelerated gas flow 550, which may be subsonic, and/or at a lower subsonic speed or rate than an upstream subsonic flow. For example, the flow may be decelerated and/or slowed from supersonic speeds to subsonic speeds by a first diffuser 420 and/or first shock(s) 425, and may be subsequently further slowed from subsonic speeds to lower subsonic speeds by a second diffuser 420 and/or second shock(s) 425.

If included, shocks 425 may be attached to diffuser 420, for example, on an upstream side of diffuser 420, although shocks 425 are not required to be located upstream of, attached to, diffuser 420, or to be included at all. Shocks 425 and/or diffuser 420 may disrupt and/or slow the gas flow to decelerated gas flow 550. In some embodiments, decelerated gas flow 550 may be subsonic. Diffuser 420 may disrupt gas flow 530 and/or create or enhance non-laminar flow characteristics of decelerated gas flow 550, which may, for example, occur prior to decelerated gas flow 550 flowing to and/or past catalyst or filter 430 and/or heat exchanger 440, if included. Generally, a slowed and/or non-laminar flow encountering catalyst or filter 430 and/or heat exchanger 440 will increase the efficiency of the catalytic, filtering, and/or heat exchange processes before return gas flow 560 returns to blower 500 via gas flow outlet pipe 565.

Diffuser 420 may include a subsonic portion, a sonic portion, or both. Diffuser 420 may include a central element placed into the midst of the gas flow path in order to slow or decelerate the gas flow to the decelerated gas flow 550. In some embodiments, diffuser 420 may first decelerate the gas flow from supersonic speeds to subsonic speeds, and subsequently decelerate the subsonic gas flow to an even slower subsonic speed. In some embodiments, diffusion may be caused by diffuser 420 and/or shocks 425 placed within a diffuser channel formed between and/or at least partially defined by at least a portion of dielectric layer 210 and/or at least a portion of inner casing 300. The portions of dielectric layer 210 and/or inner casing 300 forming the diffuser channel may be substantially downstream of optical resonator cavity 400.

In some embodiments, diffuser 420 may be substantially centrally located between outer shell 200 and inner casing 300, and/or may split a flow (e.g. supersonic flow 530, subsonic flow 540, and/or decelerated gas flow 550) substantially in half. Diffuser 420 may be substantially asymmetrical in shape, and/or may be curved to substantially match the profile of outer shell 200 and/or inner casing 300, although it is understood that diffuser 420 may be any of a variety of shapes and/or profiles, and/or may be shaped or formed independently of outer shell 200, inner casing 300, or both. Diffuser 420 may have a leading or first edge 421, a widest point 423, and/or a trailing or second edge 426. In these or other embodiments, first edge 421 may be located upstream in the gas flow path and may be relatively thin, diffuser 420 may widen from first edge 421 until reaching widest point 423, and/or diffuser 420 may taper in width from widest point 423 down to a relatively thin second edge 426. Measuring the length of diffuser 420 from a beginning point at first edge 421 to a terminal point at second edge 426, in some embodiments widest point 423 may be located within the first half of the length of diffuser 420 (i.e. equally close or closer to first edge 421 than it is to second edge 426) or even within the first one quarter of the length of diffuser 420 (i.e. equally close or closer to first edge 421 than it is to a midpoint along the length of diffuser 420).

The supersonic and/or subsonic diffusers 420 may have optimal dimensions and/or form thereby efficiently using the absolute pressure present in the gas flow. For a gas speed of about Mach=2, the efficiency is about 90%, thus wave loss into the laser system is very low. The viscous losses of kinetic energy within the gas flow depend on the Mach speed and absolute pressure of the gas within the nozzle or narrowed gas flow area. For a typical gas flow having a speed of about Mach=2 and an absolute pressure located within the receiver of 200 torr, the loss of kinetic energy is about 40%. The overall loss of kinetic energy within the gas flow in the laser is thus about 50%. The beneficial result of this design with such a 50% loss in kinetic energy is due to the reduced energy requirements for increasing the pressure of the inlet gas flow 510. If there is a 50% reduction in kinetic energy, i.e., to 100 torr from the absolute pressure of 200 torr, blower 500 may require relatively low energy in order to increase the pressure back to 200 torr. The power and dimensions of the blower 500 is directly related to diffuser 420 and aerodynamic efficiency of the overall laser system. For a typical CO₂ laser with output power of 1.5 kW blower 500 may require only about 2-3 kW.

Blower 500 may pressurize and/or raise the velocity of the gas or gas medium used in the laser to create and/or cause inlet gas flow 510 to enter gas inlet pipe distributor (or gas distributor) 520. Gas distributor 520 may have a mesh or screen 525, which may facilitate and/or cause inlet gas flow 510 to become more uniform and/or even as it passes into the area between the outer shell 200 and inner casing 300. A flow deflector 220 may be located adjacent inner casing 300 and/or mesh 525 to, for example, direct the gas flow into the subsonic gas flow area 540 and/or to create or enhance desirable flow characteristics. It is understood that flow deflector 220 is optional, and that, if included, may be located virtually anywhere, including, but not limited to, adjacent any or all of inner casing 300, outer shell 200, gas distributor 520, and/or mesh 525, or anywhere else within outer shell 200, gas distributor 520, a gas flow outlet pipe 565, a gas flow inlet pipe 515, and/or blower 500. The gas flow may operate in a closed circuit or loop, which may allow for more efficient utilization of the gas and/or maintenance of the appropriate environmental requirements. In some embodiments, the mesh 525 may be made of metal, such as stainless steel for example, although it is understood that any of a variety of materials may be used.

Chemical catalyst or filter 430 may use any of a variety of chemicals, materials, or components to achieve a catalytic process. For example, chemical catalyst 430 may primarily comprise platinum and/or include at least some amount of platinum. In some embodiments, a platinum based catalyst may be useful if the gas flows 510, 540, 530, 550, 560 is or includes a gas laser medium [CO₂:N₂:He]. Chemical catalyst or filter 430 may include, instead of or in addition to a chemical catalyst, a filter for gas flow 550. A gas laser medium including [CO:He] may be used instead of or in addition to [CO₂:N₂:He]. In some embodiments, a gas medium may include CO and filter 430 may filter CO₂ molecules and/or chemical catalyst 430 may convert CO₂ to CO and/or O. Heat exchanger 440 may cool a relatively hot decelerated gas flow 550, which may be approximately 400K, to a relatively cool return gas flow 560, which may be cooled to approximately room temperature before returning to blower 500.

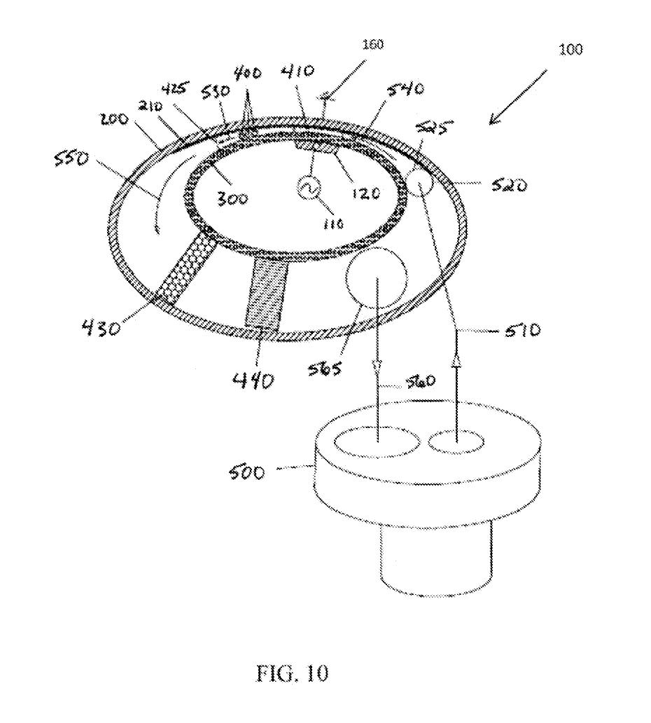

FIG. 10 illustrates an alternative embodiment to that illustrated in FIGS. 8 and 9. The cylindrical outer shell 200 and inner casing 300 are depicted as having substantially elliptical cross sections in FIG. 10 instead of the substantially circular cross sections depicted in FIGS. 8 and 9. It is understood that the cylindrical elliptical and cylindrical circular cross sections of the outer shell 200 and inner casing 300 are merely examples of shapes that may be used, and that outer shell 200 and/or inner casing 300 may be any of a variety of shapes, including, but not limited to, round, ovate, triangular, square, rectangular, circular, elliptical, polygonal, arcuate, or any other shape, or any combination thereof. It is further understood that, although FIGS. 8-10 depict outer shell 200 and inner casing 300 as having substantially similar cross sectional shapes in each respective figure, the shapes are not dependent on one another and inner casing 300 may be shaped independently and/or without regard to the shaping of outer shell 200, or vice versa.

FIG. 10 depicts heat exchanger 440 positioned downstream of catalyst or filter 430 in spaced apart relation thereto, whereas FIGS. 8 and 9 show heat exchanger 440 abutting and/or adjacent to catalyst or filter 430. It is understood that catalyst or filter 430 and heat exchanger 440 may be in physical contact or proximity, although it is not required, regardless of the cross sectional shape of outer shell 200 and/or inner casing 300. Furthermore, it is understood that, although heat exchanger 440 is depicted as being downstream of catalyst or filter 430, heat exchanger 440 may be downstream of catalyst or filter 430 and/or heat exchanger 440 and catalyst or filter 430 may be located together in the stream of decelerated gas flow 550. Further still, it is understood that, although FIG. 10 does not depict a diffuser 420 and/or shocks 425, such may be included in any of a variety of forms and/or locations, such as, for example, as described above in reference to FIGS. 8 and 9.

Inner casing 300 and/or dielectric insulating layer 210 may be formed of dielectric material or materials. Thus, in addition to forming a portion of the gas flow path 530, 540, inner casing 300 may acts as a dielectric insulator of the RF electrode 120 from the gas and plasma. In some embodiments, the RF electrode 120 may increase the plasma density up to about 50 W/cm³ or more. In some embodiments, the laser may have a substantially electrode-less plasma cavity 410 wherein the plasma cavity 410 may be free from intrusion of the electrical connections, electrodes or other excitation mechanism or structure.

Dielectric insulating layer 210 may prevent the outer shell 200 from generating any or excessive hot spots within the plasma and/or gas flow. In some embodiments inner casing 300 may at least partially be made of ceramic Alumina Oxide [Al₂O₃]. Outer shell 200 may be at least partially made of at least one of aluminum and an aluminum alloy. In some embodiments, outer shell 200 may be made of a conductive material, such as aluminum or an aluminum alloy, for example, and may thereby act as an electrically grounded external electrode in addition to providing a housing for the internal laser components. In these or other embodiments, dielectric insulating layer 210 may at least partially be made of quartz. In some embodiments, the wall thickness of inner casing 300 may be between about 3 and about 13 mm. In these or other embodiments, the wall thickness of said dielectric insulating layer 210 may be between about 0.5 and about 6 mm.

Diffuser 420, shock(s) 425, and/or any component thereof, or any combination thereof, may be formed substantially of aluminum and/or a ceramic material. It is understood that any of a variety of materials may be used to construct any or all of outer shell 200, dielectric insulating layer 210, inner casing 300, diffuser 420, shock(s) 425, and/or any other component described herein, and that any or all materials disclosed herein are merely exemplary and are not limiting. It is further understood that any of a variety of sizes and shapes of any or all components described herein, including wall thicknesses, lengths, widths, or any other dimensions, are merely exemplary and are not limiting.

In an exemplary embodiment, a diffusing gas flow laser 100 may operate as follows: Blower 500 with a speed rotation of about 20,000 rpm supplies cooled inlet gas flow 510 with a pressure ratio of about 1.1 to about 2. The gas dynamic medium may be, for example, [CO2 N2:He] or [CO:He], and/or may be supplied to gas distributor 520, through mesh 525, into plasma cavity 410 into the optical resonator cavity 400. Within the plasma cavity 410, the gas may be excited by a radio frequency field of low voltage (e.g. about 1000 V) between the RF electrode 120 and the electrically grounded outer shell 200 and/or electrical ground 160. The RF excitation results in excitation of the laser gas medium by ionization of atoms and molecules of the laser gas through electronic oscillation in the thin layers adjacent the surface of the inner casing 300 and the dielectric insulating layer 210 of outer shell 200. Dynamic gas flow may also pass through one or more gas flow deflectors 220 as desired, for example, for adjustment and narrowing of the gas flow into plasma cavity 410 and/or optical resonator cavity 400. Passing the excited gas into and/or within the optical resonator cavity 400 may allow amplification of output laser 140, for example, by passing optical beam(s) 130 between the optical resonator mirrors 405 and exiting the resonator frame 240 and/or resonator rods 250 via, for example, optical coupler 640 positioned at focusing lens 650.

Continuing this example, the gas flow leaving the plasma cavity 410 may be substantially laminar and pass toward shocks 425 and/or diffuser 420 which may slow the gas flow and/or disrupt the laminar flow characteristics to cause decelerated gas flow 550. Decelerated gas flow 550 may realize and/or approach low subsonic speeds in some embodiments. Decelerated gas flow 550 may be un-catalyzed, unfiltered, and/or hot (e.g. about 400K) and thus may pass toward the catalyst or filter 430 and heat exchanger 440, wherein the gas is efficiently catalyzed, filtered, and cooled down to ambient temperature for increased operating efficiency. Outlet gas flow 560 may then return to the blower 500 to be recycled and/or form a closed loop system.

It is understood that the above example(s) is/are merely one of a wide variety of possible embodiments and, therefore, should not be considered limiting in any way.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The foregoing description of several methods and embodiments have been presented for purposes of illustration. It is not intended to be exhaustive or to limit the precise steps and/or forms disclosed, and obviously many modifications and variations are possible in light of the above teaching. It is intended that the scope and all equivalents be defined by the claims appended hereto.

What is claimed is:

1. A closed loop gas flow laser, comprising:
an outer shell and an inner casing eccentrically aligned within said outer shell, said outer shell electrically grounded and said inner casing including a dielectric material;
an inner surface of said inner casing on which a radio frequency (RF) electrode is positioned, said RF electrode in electrical contact with a RF power supply;
a gas flow path substantially formed between said outer shell and said inner casing;
a plasma cavity and an optical resonator cavity formed between said outer shell and said inner casing in said gas flow path;
a dielectric insulating layer on an inner surface of said outer shell positioned adjacent at least one of said plasma cavity and said optical resonator cavity;
a diffuser located in said gas flow path downstream of said optical resonator cavity, said diffuser having a first edge proximate said optical resonator and a second edge opposite said first edge, said diffuser widening from said first edge to a widest point and tapering from said widest point to said second edge; and
an external blower in fluid communication with said gas flow path.

2. The gas flow laser of claim 1, further comprising at least one additional diffuser in said gas flow path, wherein at least one of said diffuser and said at least one additional diffuser is a supersonic diffuser and the other is a subsonic diffuser.

3. The gas flow laser of claim 1, wherein said outer shell has a circular cross section.

4. The gas flow laser of claim 1, wherein said outer shell has an elliptical cross section.

5. The gas flow laser of claim 1, further comprising a plurality of laser modules optically combined and sharing a common optical resonator cavity.

6. The gas flow laser of claim 1, further comprising an optical fiber in optical communication with an output laser from said optical resonator and an optical collimator in optical communication with said optical fiber, said optical fiber optically interposed between said output laser and said optical collimator.

7. The gas flow laser of claim 1 further comprising an optical resonator frame in sealed combination with said outer shell.

8. The gas flow laser of claim 1 further comprising one or more optical resonator rods attached to a laser module, said laser module in sealed combination with said outer shell.

9. The gas flow laser of claim 1, further comprising a heat exchanger downstream of said optical resonator cavity.

10. The gas flow laser of claim 1, wherein said optical resonator is positioned within said plasma cavity.

11. The gas flow laser of claim 1, wherein said optical resonator is placed at least partially downstream of said plasma cavity.

12. The gas flow laser of claim 1, wherein said outer shell and said inner casing are hermetically sealed with at least one side flange.

13. The gas flow laser of claim 1, wherein said widest point of said diffuser is within a first half of said diffuser measured from said first edge.

14. The gas flow laser of claim 13, wherein said widest point of said diffuser is within a first quarter of said diffuser measured from said first edge.

15. A gas flow laser, comprising:
an outer shell and an inner casing, said inner casing eccentrically aligned with said outer shell thereby creating a gas flow path having a narrowed gas flow area;
said inner casing having a radio frequency (RF) electrode on an interior surface adjacent said narrowed gas flow area, said RF electrode in electrical communication with a RF power supply;
a dielectric insulating layer on an interior surface of said outer shell, said dielectric insulating layer positioned opposite said narrowed gas flow area from said RF electrode;
a plasma cavity formed in said narrowed gas flow area and interposed between said RF electrode and said interior surface of said outer shell;
an optical resonator in said narrowed gas flow area and at least one of within said plasma cavity and downstream of said plasma cavity, said optical resonator at least partially defined by an optical source and an output coupler;
at least one diffuser located downstream of said optical resonator, said at least one diffuser having a first edge proximate said optical resonator, a second edge opposite said first edge, and a widest point between said first edge and said second edge.

16. The gas flow laser of claim 15, further comprising a blower providing an inlet gas flow to said gas flow path.

17. The gas flow laser of claim 16, wherein said gas flow path includes a flow deflector positioned within said gas flow path.

18. The gas flow laser of claim 16, further comprising at least one of a filter, a catalyst, and a heat exchanger positioned downstream of said optical resonator.

19. The gas flow laser of claim 18, further comprising at least two of a filter, a catalyst, and a heat exchanger positioned downstream of said optical resonator.

20. The gas flow laser of claim 15, wherein said optical resonator includes one or more resonator mirrors in optical communication with said optical source and said output coupler.

21. A gas flow laser, comprising:
an elliptically shaped outer shell and an elliptically shaped inner casing, said inner casing eccentrically aligned with said outer shell thereby creating a gas flow path having a narrowed gas flow area between the elliptically shaped outer shell and the elliptically shaped inner casing;
the inner casing having a radio frequency electrode on an interior surface adjacent said narrowed gas flow area, said RF electrode in electrical communication with a RF power supply;
a dielectric insulating layer on an interior surface of said outer shell, said dielectric insulating layer positioned opposite said narrowed gas flow area from said RF electrode;
a plasma cavity formed in said narrowed gas flow area and interposed between said RF electrode and said interior surface of said outer shell in the narrowed gas flow area between the eccentrically aligned elliptically shaped outer shell and the elliptically shaped inner casing;
an optical resonator in said narrowed gas flow area and at least one of within said plasma cavity and downstream of said plasma cavity, said optical resonator at least partially defined by an optical source and an output coupler;
at least one gas decelerating shock located downstream of said optical resonator, said at least one shock positioned at a widening point of the eccentrically aligned elliptically shaped outer shell and elliptically shaped inner casing;
a blower providing an inlet gas flow to said gas flow path;
at least one of a filter and a catalyst combined with a heat exchanger positioned downstream of said optical resonator;
wherein the heat exchanger is spaced apart from the at least one of the filter and catalyst;
the eccentrically aligned outer shell and inner shell forming the narrowed gas flow area positioned adjacent the plasma cavity and having a wider separation than said narrowed gas flow area adjacent the heat exchanger.
